(19) United States
(12) Patent Application Publication
(10) Pub. No.: US 2016/0217437 A1
(43) Pub. Date: Jul. 28, 2016

(54) METHOD FOR GENERATING INTANGIBLE BIT MONEY MANAGED AS DATA AND SYSTEM FOR PROVIDING SERVICES RELEVANT TO SAME

(71) Applicant: Boktae PARK, Gwangmyeong (KR)

(72) Inventor: Boktae PARK, Gwangmyeong (KR)

(21) Appl. No.: 14/893,037

(22) PCT Filed: May 21, 2014
(86) PCT No.: PCT/KR2014/004532

§ 371 Date: Mar. 25, 2016

(30) Foreign Application Priority Data
May 22, 2013 (KR) 10-2013-0057526

(51) Int. Cl. G06Q 20/06; G06Q 20/38

(52) U.S. Cl. CPC G06Q 20/065; G06Q 20/3821

(57) ABSTRACT

The present invention generates intangible bit money managed as data that can be used as a third currency in order to facilitate efficiency and security in financial transactions in, along with being in compliance with the development of the world, so that the inconveniences and danger accompanying the circulation of the cash carried by a person are eliminated, and the national budget for issuing new currency to replace worn old currency can be saved. It provides a system for depositing and withdrawing money without a bank account even with a personal email, smart TV, communicable game device, or mobile terminal, etc. alone. Also, the bit money generated by the present invention can be tracked for circulation of the attributes thereof, and thus is a payment means of a new paradigm for protecting the property of a client from illegal transactions such as hacking.

### TECHNICAL FIELD

The present invention relates to a financial transaction, where convenience, efficiency, and stability are required as an offline teller service and types of online transactions such as internet banking, phone banking, etc. are diversified. Therefore, the present invention pertains to technical fields relevant to methods of generating, modifying, and updating intangible bit money as payment means in financial transactions, a method for providing services enabling the same to be stably used in financial transactions, and operations thereof. The intangible bit money managed as data will be a new payment means for financial transactions as well as allow secure transactions by adopting double encryption and dualized security services in financial transactions. The bit money may be generated in a binary digit, which is the minimum information unit to be recognized at a computer or other terminals that can verify a recording medium, and may be provided at its service system. The present invention is relevant to technologies allowing the approval authority, which is a financial institution, to determine its size and property according to the policy of a financial company so that it may function as new currency, and being necessary for generation and operation of the bit money. Also, the present invention is relevant to technologies for encrypting hierarchy and properties and optimizing them for security against forgery and alteration, etc. and for providing services relevant to the same.

### BACKGROUND ART

In conventional financial transactions, there are cash, and securities such as a cashier's check and a promissory note as money transfer means for offline payments, and there are methods of internet banking, phone banking, etc. as those for online payments. Recently used are a rechargeable card using a simple storage device and an electronic wallet such as a pre-paid card or a deferred payment card. The present invention relates to technologies for generating intangible bit money managed as data that can replace the conventional financial payment methods and means, and for providing services relevant to the same. It is expected that the bit money and its operation technologies, which will provide an effective system in the upcoming future financial industry, will be applied to a number of transactions such as transactions between approval authorities to which an authorization institution, as a national institution, has delegated authority over financial transactions and the approved institutions, transactions between approval authorities using it according to needs, companies, individuals, etc. Facilitation of financial transactions requires a new type of system with a new form and method of the transactions between each entity to solve social and economic problems. The present invention relates to an intangible currency that provides high level of security, efficiency, and convenience, which are required due to unique characteristics as currency. In particular, in consideration of using intangible money managed as data, the present invention generates the properties and hierarchies of bit money with double encryption and dualized technologies and allows bit money to be safely transacted in a dedicated system, and thereby achieves stable security. The bit money involves security technologies necessary for various transactions and transaction methods, and thus provides convenience and economic feasibility as well as protects financial assets against illegal acts such as hacking. Further, the bit money resolves inconveniences of carrying cash or securities such as a check and concerns about loss thereof. Further, the bit money provides transparent money transfer route in its use to change an economic structure, and thereby facilitates good sense of sound financial transaction. Moreover, it may improve economic inefficiency due to issuance and re-issuance of prior payment means for transactions such as cash and a cashier's check.

### DETAILED DESCRIPTION ON THE INVENTION

### Technical Problem

As a currency with unique characteristics, cash has conservative and closed properties, and thus, developments of its culture has been slower than other industries. This is because the highest stability and reliability should be secured and thus it has taken long time until even securities are widespread. However, social concerns arise due to a forgery and counterfeit cash and securities, and financial institutions as well as customers suffer damages even from illegal methods such as hacking, parsing, and phishing in online transactions. To resolve such problems, the present invention provides a method of generating intangible money managed as data and providing services relevant to the same for resolving problems in offline cash transactions and online transactions.

### Technical Solution

To achieve the above objectives, there is provided a method of generating intangible money managed as data and providing services necessary for operating the same. According to an embodiment of the present invention, the technical problems in generating and operating bit money is resolved by allowing a non-authorized person or system to freely deposit, withdraw, and transfer bit money generated at authorized or approved institution as well as generating and operating the bit money such that it is impossible to duplicate, falsify, or counterfeit the bit money. When modifying the generated bit money by an approval institution having an authority thereover and a user, as in its generation, it should be free from an unauthorized person or system. The generation and security technologies capable of verifying a transfer route for each process where bit money is transferred for its deposit or withdrawal should be free from interference by other unauthorized environments in the operation process of providing the services. In its generation and transfer, bit money should go through an encrypted kernel that can verify it to assure security. When generating bit money at the approval institution for generation of bit money, the credential for bit money itself and that for one who generates it should be verified and a common security required by other approval institutions and an encrypted confirmation process should be gone through. After generation of bit money, properties including the amount of money as presented in an expression form for describing bit money should be reliable in security against duplication, falsification, counterfeiting, etc. Such properties are encrypted with public key and private key encryption algorithms by doubling and dualizing the encryptions for all of an approval institution generating bit money, the generator of bit money, and its transferee, and it should be standardized to ensure integrity in its decryption. Further, the hierarchy of bit money is stored in a randomized manner as provided by the approval institution in a binary digit space, and such processes should be performed on the encrypted kernel of the approval institution for high-level of security. Moreover, transfer information of bit money is collected per each distribution process for its history management through an online and offline mobile, a PC, a USB memory, a smart card, an e-mail, a smart TV, a game console with communication capability, or other user specific terminals capable of storing bit money.

The present invention includes a method and a system for generating intangible currency and providing services thereof that enable bit money encrypted in a doubled and dualized manner at ab authorized or approved institution to be distributed while maintaining the integrity state during its decryption.

In accordance with an embodiment of the present invention, there is provided a method for providing bit money distribution service provided at a server for providing intangible bit money distribution service comprising: receiving creation event message that bit money has been created by a creator terminal, via an authorization institution server, the creation event message including creator information, amount information, distribution history information, and creator encryption code information; storing the creator information, the amount information, the distribution history information, and the creator encryption code information; transmitting the creator information, the amount information, the distribution history information, and the creator encryption code information to a transferee terminal to which the creator terminal transfers bit money; via the authorization institution server and an approval institution server, receiving from the transferee terminal a transfer event message that the bit money has been transferred to the transferee terminal; when a payment event message is received by the transferee terminal, transmitting approval confirmation on the transmission of the creator encryption code information to the creator terminal; and when receiving approval confirmation data from the creator terminal, transmitting the payment event message received from the transferee terminal to a store terminal installed in a store via the authorization institution server and the approval institution server, wherein the server for providing bit money distribution service, in response to the creation event message, dualizes the creator encryption code of the creator terminal and a transferee encryption code of the transferee terminal as a pair of encryption codes such that they are activated only at the creator terminal and the transferee terminal, when the transfer event message is received by the transferee terminal, updating history information from the creator terminal to the transferee terminal to the distribution history information, and when confirmation data on the payment event message is received from the store terminal, updating history information from the transferee to the store to the distribution history information.

In the embodiment, the method for providing intangible bit money distribution service further comprising before transferring the bit money from the creator terminal to the transferee terminal is completed, receiving a creator encryption code input of the creator terminal and a transferee encryption code input of the transferee terminal, and comparing the creator encryption code and the transferee encryption code with pre-stored encryption code data.

In the embodiment, wherein at least one information for the bit money is encrypted with a private key and a public key, and then re-encrypted with the creator encryption code and the transferee encryption code.

In the embodiment, wherein if the creation event message includes a transfer due date, the bit money is not transferred to the transferee terminal until the transfer due date.

In the embodiment, the method for providing intangible bit money distribution service further comprising: receiving credential authentication information from the creator terminal and the transferee terminal via the authorization institution server and the approval institution server.

In the embodiment, wherein the creation event message further includes bio metric information and an identification number and the server receives bio metric information and identification number of a user of the transferee terminal from the transferee terminal after the bit money is transferred to the transferee.

In the embodiment, wherein the bit money is displayed with a barcode or an image code.

In the embodiment, wherein when the creation of the bit money from the creator terminal is completed, the server decreases a first amount of money from possessed money of the creator terminal and increases concurrently a second amount of the bit money based on the first amount using an equality function algorithm.

In the embodiment, wherein integrity is checked upon the encryption or decryption of at least one information for the bit money.

In the embodiment, wherein the creator encryption code and the transferee encryption code are encrypted with a private key and a public key.

In the embodiment, wherein the creator terminal transmits the bit money to the transferee terminal through one of an e-mail of the transferee terminal, a smart terminal, a desktop computer, a smart card, a USB memory, or a smart TV.

In the embodiment, wherein the bit money includes a unit corresponding to at least one type of currency.

In the embodiment, wherein the information included in the creation event message for the bit money, the history information from the creator to the transferee, the history information from the transferee to the store, and the transferee encryption code are stored as binary bit data or bit data.

### Advantageous Effect

As describe above, the present invention is a new paradigm of financial transactions for resolving structural problems in offline money transfer such as cash deposit and withdrawal, such as inconvenience in carrying cash and paying on cash, and riskiness resulting from carrying cash. The bit money according to the present invention is intangible currency managed as data, which may resolve social problems as well as the above problems and further resolve institutional problems of finance by tracking illegal money transfers resulting from hacking, parsing, and phishing, etc. Further, a specified account issued by an approval institution has been required to deposit or withdraw money to or from an account so far, the intangible bit money enables a user to receive a deposit via the user's online and offline mobile, PC, USB memory, smart card, e-mail, smart TV, game console with communication capability, or other user specific terminals, and thereby provides convenience in use. Also, it may save huge cost required for an authorized institution to issue new bills to replace bills damaged during their distribution as well as cost required to issue cashier's checks and securities. Authorization institutions may resolve significant parts of institutional and social problems in circulating and distributing cash by distributing minimum amount of currency. Approved institutions may also increase national and social efficiency by saving cost required to store cash. Above all, as the use of intangible bit money increases the closed financial transaction cultures would gradually improve themselves, such voluntary improvements in the financial transaction cultures would help overall society. If the use of intangible bit money as sought by the present invention is initiated, not only a transaction such as deposit or withdrawal of money becomes more efficient, but also accurate statistics on various types of policy issues can be obtained by analyzing macroscopic capital flow so that it contributes to national and social economic policies.

### BRIEF DESCRIPTION OF THE DRAWINGS

FIG. 1 is a basic diagram illustrating generation of intangible bit money managed as data.

FIG. 2 is a basic diagram illustrating modification of bit money.

FIG. 3 is a hierarchy diagram for properties of bit money.

FIG. 4 is a flow chart of generation of bit money.

FIG. 5 is a procedure diagram of a process performed upon request for modifying properties of bit money.

FIG. 6 is a flow chart of tasks performed when modifying bit money.

FIG. 7 is a flow chart of request and generation of virtual bit money.

FIG. 8 is a flow chart of withdrawal transfer of bit money.

FIG. 9 is a flow chart of deposit transfer of bit money.

FIG. 10 is a diagram illustrating work operations by a bit money administrator in an approval institution.

FIG. 11 is a diagram illustrating operations of bit money by a user in approval institutions.

FIG. 12 is a diagram illustrating operations of bit money between users outside approval institutions.

FIG. 13 is an operation diagram of a dedicated system for bit money.

FIG. 14 is a basic diagram illustrating double encryption and encryption display dualization of a bit money system.

FIG. 15 is a basic diagram illustrating a settlement between bit money approval institutions.

FIG. 16 is a block diagram of an encryption display dualization for bit money operation.

FIG. 17 is a block diagram of a system for providing a bit money service.

### BEST MODE FOR THE INVENTION

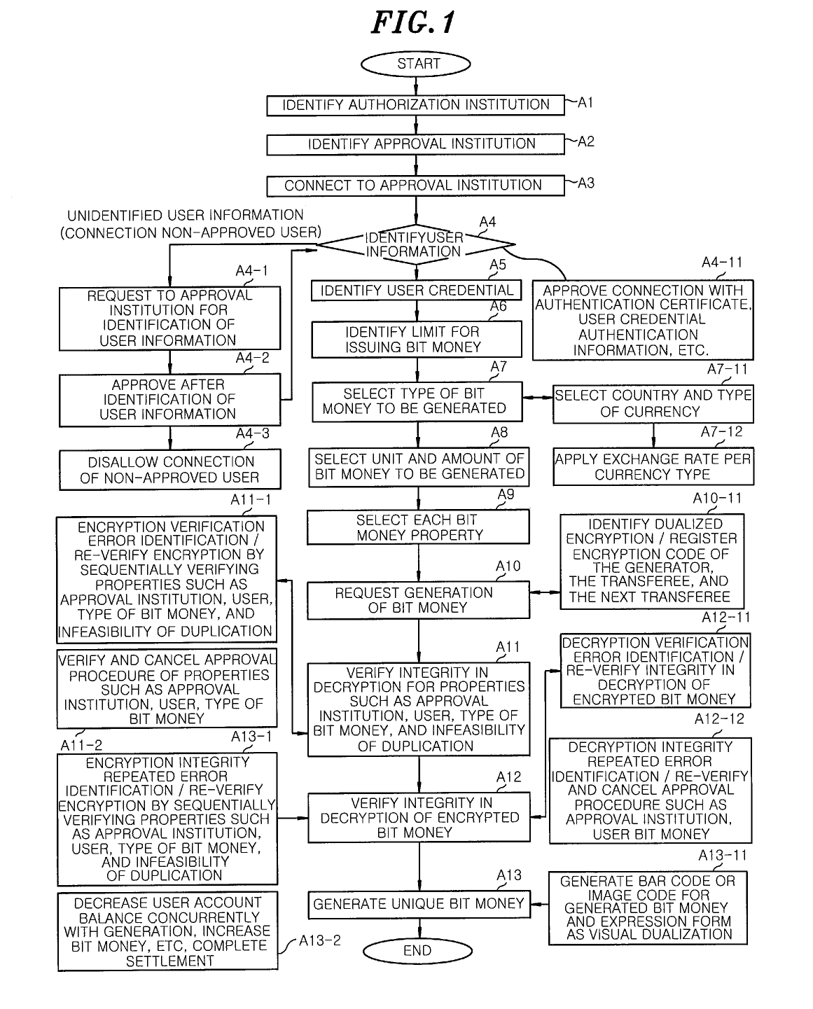

With reference to the accompanying drawings, the objectives, features, and advantages of the bit money as discussed above will be described in more detail with preferable embodiments of the present invention. FIG. 1 of the present invention for achieving the objectives as discussed above is a basic diagram illustrating a method and technology for generating the intangible unique bit money managed as data.

Step A1 indicates an institution that authorizes approval institutions capable of handling financial transactions.

Step A2 indicates an approval institution providing financial transaction services. At step A3, a user visits an offline counter of an approval institution or connects to an online operation system provide by an approval institution. At step A4, the approval institution identifies information of the user who attempts transaction. Herein, the user connects with an authentication certificate or the connection is approved with user credential authentication information (step A4-11). An unidentified user provides the user information to the approval institution and requests approval of the credential for connection (step A4-1) to receive approval of the credential for connection (step A4-2). Non-approved users are not permitted to connect to the approval institution for transactions (step A4-3).

At step A5, once a user credential is identified at a counter of the approval institution or its operation system, at step A6, an access is permitted such that bit money can be issued to a designated account of the user issued by the approval institution, and an amount of cash possession limit is identified.

At step A7, a country and the type of currency for which the bit money is to be generated is selected when generating bit money from cash (step A7-11) and an exchange rate system for each currency, as provided by the approval institution, is applied to identify the limit for the bit money (step A7-12).

Step A8 selects the unit price per each amount of bit money to be generated and the amount of bit money.

Step A9 registers external properties for each bit money. Once a deadline for exchanging for cash, among the external properties, is designated, the user to whom the bit money is transferred is restricted from exchanging the bit money for cash even after depositing the bit money to the approval institution by the deadline.

Step A10 requests generation of each bit money to be issued for the amount of money possessed in the designated account. In this process, encryption codes to be used by the generator, the transferee, and the next transferee are generated for registration. In this process, a pair of encryption codes to be used by the payer and transferee are respectively dualized and dimensionalized by respective encryption browsers to be used by the respective users so that it is generated to be activated only for terminals for which the user is granted approval or browsers used by the user (step A10-11). Here, the payer may be the generator of the generator terminal and the transferee may be the transferee of the transferee terminal.

Step A11 encrypts the generator or the user of the bit money and its properties such as a type, unit, and amount of money with a public key or a private key provided by the approval institution such that modification such as duplication, falsification, or counterfeiting thereof is infeasible. The properties of the bit money are sequentially verified when bit money is encrypted at the approval institution (step A11-1). If an error occurs during the encryption verification, the process is repeated from the verification of the procedures from the approval institution (step A11-2).

Step A12 should check integrity in decryption for the encrypted bit money so that no error occurs when the user uses it. If an error occurs during the decryption verification, the properties and procedures for the encrypted bit money are sequentially re-verified (step A12-11).

Concurrently with the generation of bit money, step A13 decreases the balance of the user account by the same amount as the increase of bit money. In this process, an equality function system should be applied to the balance so as to avoid any difference between the increase of bit money and decrease of cash due to a time lag (step A13-2). In other words, when the generation of bit money from the generator terminal is completed, the bit money distribution service providing server can decrease the amount of possessed cash of the generator terminal and at the same time increase the bit money by using the equality function algorism. Through the process for generating bit money as above, the unique distinct bit money is issued. Generated is the unique intangible bit money managed as data and not overlapping since it includes a country, an authorization institution, a type of bit money, a standard, and a serial number (step A13-1). A bar code or image code is generated so that transfer or tracking of the generated bit money can be managed on the system (step A13-11), and it is generated and managed in a dimensionalized expression form as a visual dualization so that it is possible to identify it but infeasible to duplicate, falsify, or counterfeit it. In other words, the bit money can be displayed in the form of a bar code or an image code.

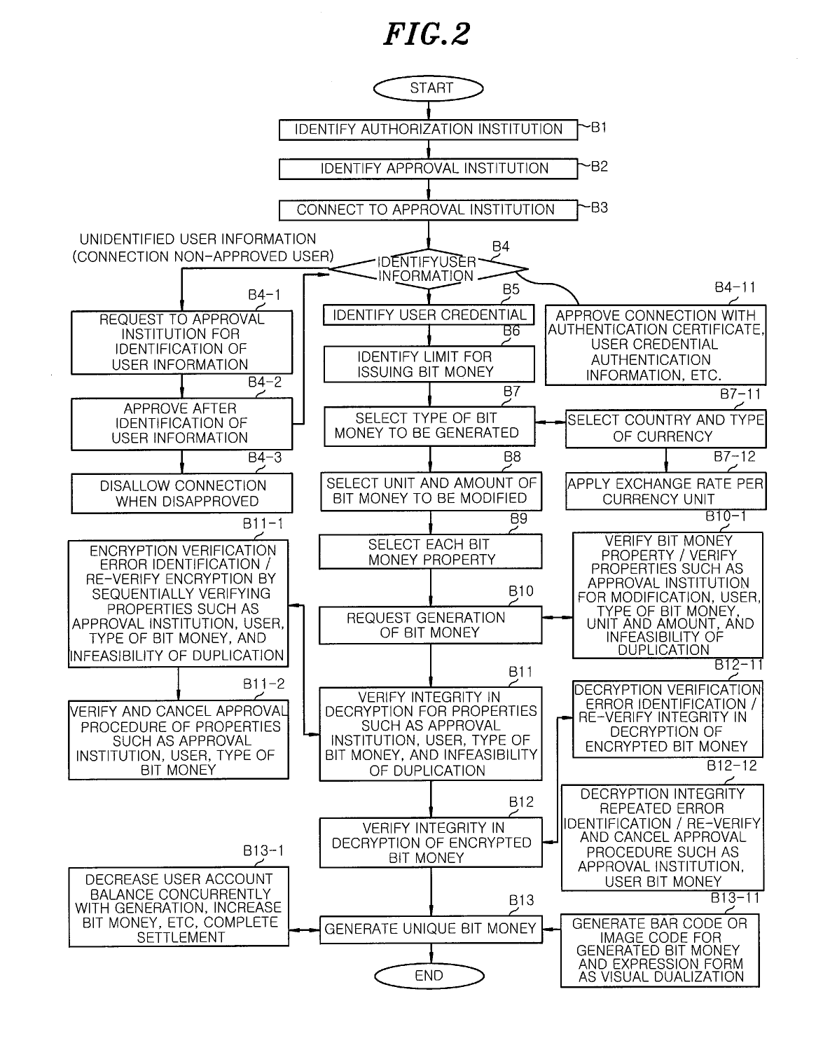

FIG. 2 is a basic diagram illustrating a sequence of modifying the generated bit money as described in FIG. 1.

Step B1 indicates an institution that authorizes approval institutions capable of handling financial transactions.

Step B2 indicates an approval institution providing whole services for financial transaction. At step B3, a user visits an offline counter of an approval institution or connects to an online operation system of an approval institution. At step B4, the approval institution identifies information of the user who attempts transaction. Herein, the user connects with an authentication certificate or the connection is approved with user credential authentication information (step B4-11). An unidentified user provides the user information to the approval institution and requests approval of the credential for connection (step B4-1) to receive approval of the credential for connection. Non-approved users are not permitted to connect to the approval institution for transactions (step B4-3).

At step B5, once a user credential is identified at online or offline environments, at step B6, the amount of possessed cash is identified by accessing information that enables bit money to be issued to a designated account of the user issued by the approval institution.

At step B7, a country and the type of currency for which bit money is to be generated is selected to modify internal properties and external properties of the bit money (step B7-11) and an exchange rate system for each currency, as provided by the approval institution, is applied to identify the limit for bit money (step B7-12).

Step B8 selects the unit price per amount of bit money and the amount of bit money.

Step B9 registers external properties for each bit money. Once a deadline for exchanging for cash, among the external properties, is designated, the user to whom the bit money is transferred is restricted from exchanging the bit money for cash even after depositing the bit money to the approval institution by the deadline.

Step B10 requests modification of the internal properties and external properties of each bit money to be newly issued for the amount of money possessed by the user. Encryption codes to be used by the generator, the transferee, and the next transferee are enabled to be registered (step B10-11). For the limit amount of money among the internal properties, the total amount cannot exceed the possession limit, and an equality function system should be applied so that the increasing amount corresponds to the decreasing amount and the increase and decrease occur concurrently.

Step B11 encrypts the properties such as a type, unit, amount of money of the bit money with a public key or a private key provided by the approval institution so that modification such as duplication, falsification, or counterfeiting thereof is impossible. The properties for bit money are sequentially verified when bit money is encrypted at the approval institution (step B11-1). If an error occurs during the encryption verification, the process is repeated from the verification for the procedures from the approval institution (step B11-2). The reason why it is repeated from the verification for the procedures is to exclude the cases where internal or external interrupters affect the system.

Step B12 should check integrity in decryption so that no error occurs in use of the encrypted bit money. If an error occurs during the decryption verification, it is sequentially re-verified to avoid procedural errors such as falsification or counterfeiting and to exclude interrupters' influence on internal or external properties of bit money (step B12-11).

Step B13 should apply an equality function system to decrease of the balance of the user account and increase and decrease of bit money according to its generation so as to avoid any difference between the increase of bit money and decrease of cash due to a time lag (step B13-2). Through the process for generating and modifying bit money as above, the bit money is modified and newly issued. A bar code or image code is generated so that transfer or tracking of the generated bit money can be managed on the system (step B13-11), and it is generated and managed in a dimensionalized expression form as a visual dualization so that it is possible to identify it but impossible to duplicate, falsify, or counterfeit it.

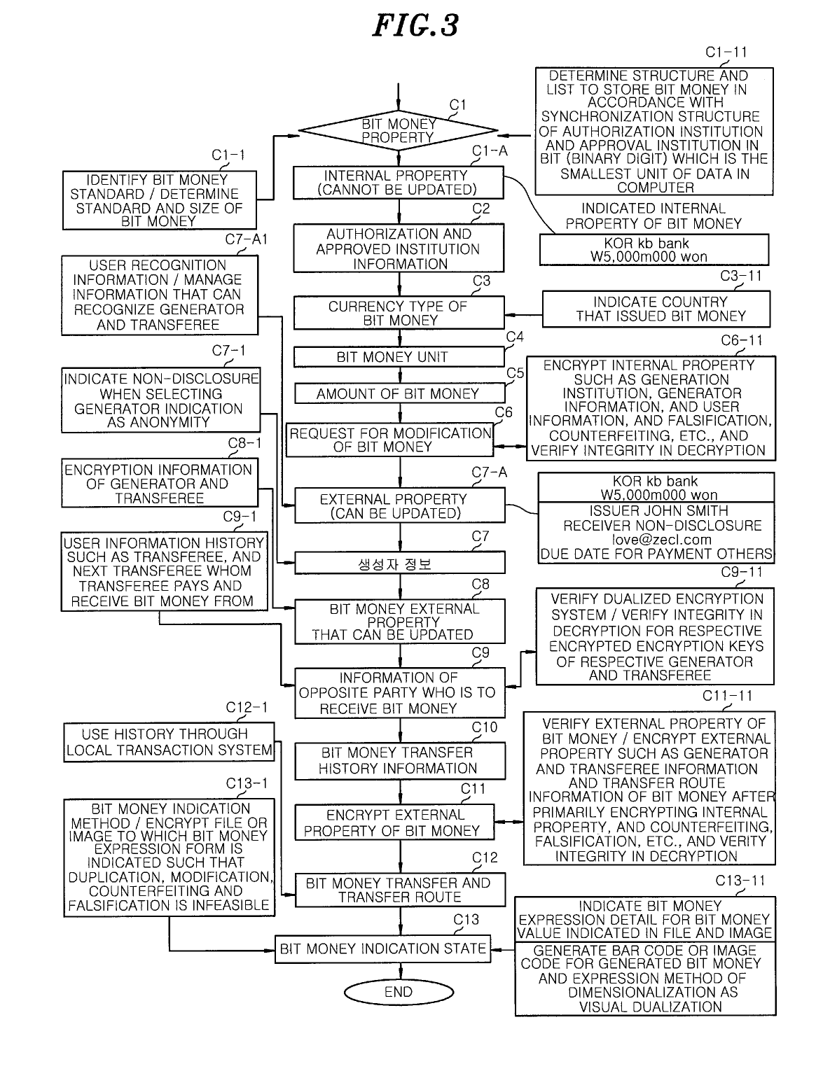

FIG. 3 is a basic diagram illustrating a hierarchy constituting the properties of intangible bit money managed as data.

Step C1, which relates to the hierarchy for configuring properties of bit money such as internal properties and external properties such as quality, classification, state, and characteristics, determines the standard and size of the bit (binary digit) to synchronize it with the operating system structure of the authorization institution and the approval institution and determines and encrypts the storing hierarchy and listing order (Step C1-11). In other words, the information included in the bit money generating event message, the information on the history from the generator to the transferee, the information on the history from the transferee to the franchise store or the business branch, and the transferee encryption code can be stored as binary bit data or bit data.

The internal properties indicated at step C1-A comprise the country, the type of currency, the amount of money, and the currency unit of the bit money to indicate the bit money such that the user is able to know the type and amount of the currency.

Step C2 indicates, among the internal properties information, information of authorization institution and approval institution capable of handling financial transactions.

Step C3 selects and registers, as the internal property, a country and a type of currency in which bit money is generated from the money possessed by a user.

Step C4 selects and registers, as the internal property, a currency unit of bit money such as dollar, yuan, and won.

Step C5 registers, as the internal property, an amount of money according to the type of currency where it is calculated in accordance with the exchange information service provided by the approval institution.

Step C6 stores the bit money's own serial number and encrypts the internal properties such that a generator and a transferee cannot access them. It enhances the security by not storing the function information at the time of the encryption so that even an administrator of the approval information cannot access the internal properties of the generated bit money. Further, the internal properties and external properties are respectively encrypted so that the generating institution and generator information of the bit money are not to be counterfeited and falsified (step C6-11).

The external properties of bit money, as shown at step C7-A, is added to the basic indication form of the internal properties which are not accessible by an administrator or a user, and upon registering an encryption code and accessing the external properties, the approval institution or the user who generated the bit money can identify the issuer, transferee, transfer route of the bit money, and designated period in which the bit money can be exchanged with cash. Further, for a closed transaction, unique information such as fingerprint or credential for identifying the generator and the transferee is registered to allow information management (step C7-A1). In other words, the generating event message of the generator terminal may include the identification number and the biological information of the transferee, and the bit money distribution service providing server can receive the identification number and the biological number from the transferee in response to the transfer event message of the transferee.

Step C7 indicates, as the external property, information of the issuer who generates the bit money, and indicates the generator as being undisclosed at a bit money display device if the user selected anonymity (step C7-1).

Step C8 includes, to the external property, information of the user who generated the bit money and the transferee including encryption information of the generator and the transferee (step C8-1) and allows the information to be updated at a dedicated system for bit money.

Step C9 verifies the integrity in decryption for the encryption key with which the information of the receiver (transferee) when the bit money is transferred for payment, as an external property, is secondarily encrypted (step C9-11), and manages the history information of the transferees (step C9-1). Further, the history information of the encryption codes of the generator and the transferee is also managed.

Step C10 manages, as the external property, transfer history information from generation of bit money until it is returned back to the approval institution.

Step C11 provides, as the external property, information of the generator and the transferee to the bit money with the primarily encrypted internal properties while allowing the information to be updated only at a dedicated system for bit money, and verifies the integrity in encryption and decryption of the external properties which prevents them from being falsified or counterfeited (step C11-11).

Step C12 manages, as the external property, a deposit and withdrawal history through a local payment system and transfer information of bit money with the parties to the transactions (step C12-1) and manages preservation states such as information of the generator and the transferee of the generated bit money and transfer route information.

Step C13 possesses a property management hierarchy that enables a type of currency, amount of money, etc. to be expressed in a dimensionalized expression form of bit money (step C13-11) and the properties of the expressed images and files as encrypted such that it is infeasible to duplicate, counterfeit, or falsify them (step C13-1). The bit money is generated and managed such that it can be identified with a bar code or image code (step C13-12).

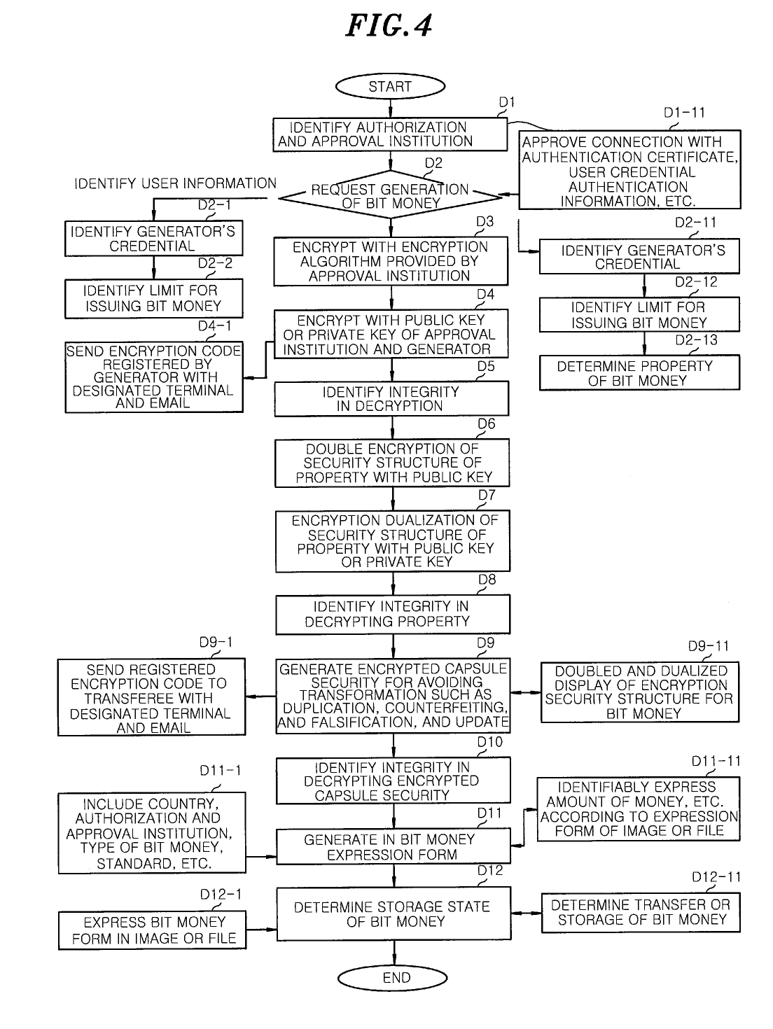

FIG. 4 is a flow chart illustrating technologies for generating intangible bit money managed as data.

Step D1 connects to the authorization institution or approval institution with an authentication certificate and user credential authentication information approved by the approval institution (step D1-11).

Step D2 receives from the approval institution confirmation on the credential of a person who is to generate bit money (step D2-1) and identifies the amount of possessed money for which the bit money is generated (step D2-2) and determines the amount of the money in accordance with the currency type for the bit money and the exchange rate information system provided by the approval institution (step D2-11). Step D3 encrypts it with a public key or a private key according to the encryption algorithm method and policy provided by the approval institution. Step D4 encrypts the information of the user who generates the bit money at the approval institution and the encryption codes provided to the transferee for double encryption with the public key or the private key provided by the approval institution. In this step, the generated encryption code is transferred to the authenticated user and transfer means such as a designated terminal, e-mail, mobile, smart TV, game console with communication capability (step D4-1).

Step D5 verifies the integrity in decryption for the primary and secondary encryptions to avoid an error occurring when the user who generated the bit money and the user to whom the bit money is transferred uses the bit money.

Step D6 encrypts the properties such as indication for expressing bit money provided to a user of the bit money with a public key provided by the approval institution.

Step D7 encrypts the properties such as management of history information produced as the user who generates the bit money and the transferee using it with a public key provided by the approval institution.

Step D8 verifies the integrity in decryption for the encrypted properties of the bit money to avoid an error occurring when the user uses them.

Step D9 generates a capsule security at a security kernel or a dedicated system provided by the approval institution to avoid transformation such as duplication, counterfeiting, or falsification, and modification or update of the bit money. In this process, a secured view (screen) with the doubled and dualized encryption is provided on the respective displays of the terminals to be used by the generator who is to pay with the bit money and the transferee (step D9-11), where the encryption codes are transferred to a designated terminal, a mobile or email, a smart TV, or a game console with communication capability for the person who receives the bit money paid by the generator (payer) to normally use them (step D9-1). In other words, the dualization is a process of re-checking the generator terminal to deposit the bit money with cash in the transferee terminal even in the case where the transmission of the bit money from the generator terminal to the transferee terminal has been completed. Therefore, in order to complete the transfer event message from the generator terminal to the transferee terminal, the generator terminal should receive from the transferee terminal the generator encryption code input of the generator terminal in response to the generator encryption code input request and the transferee encryption code input of the transferee terminal. Further, the generator encryption code and the transferee encryption code need to be identical to the pre-stored encryption data.

Step D10 verifies an integrity for the encrypted capsule security.

Step D11 identifiably expresses by including its country, approval institution, type of currency for indication, amount of money, specification, etc. to the image and file in the expression form of the bit money that can be identified by a user upon generation of the bit money (step D11-11).

Step D12 enables the stored location, storage state, amount, etc. of the generated bit money to be identified through a user terminal.

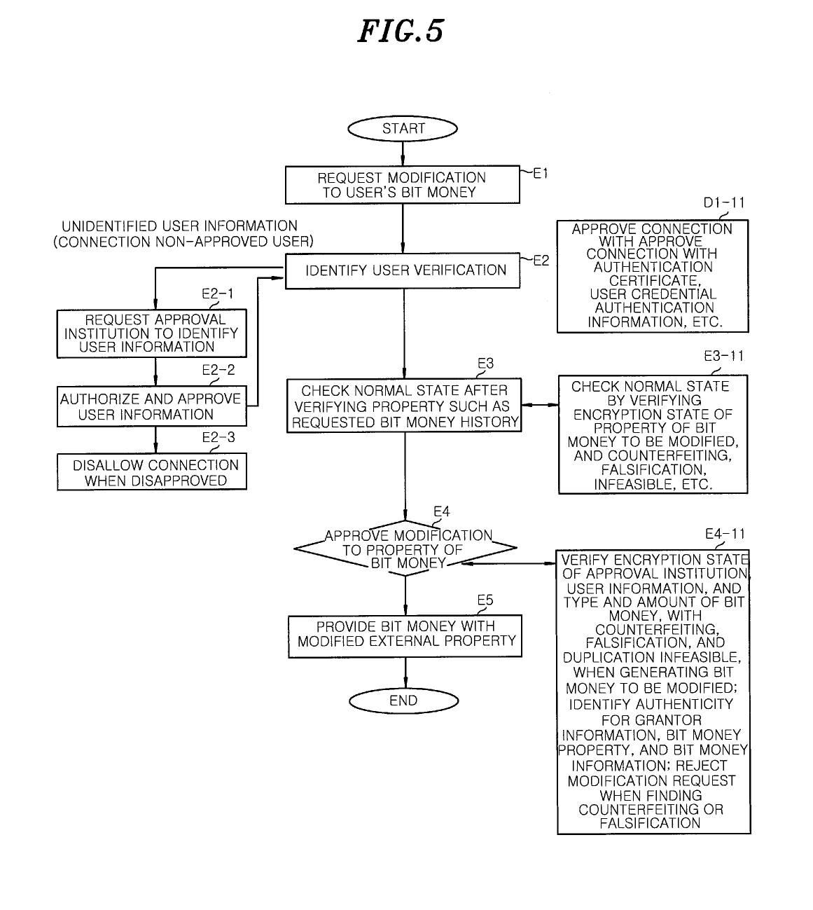

FIG. 5 is a procedure diagram a process performed upon request for modifying properties of bit money.

Step E1 requests modification to the properties of the bit money generated by a user at an approval institution.

Step E2 connects with a user authentication certificate and credential authentication information (step E2-11). If the user information is unidentified and the connection fails, a credential authentication is requested by sending the user information to the approval institution (step E2-1). If the user information is identified the connection is approved (step E2-2), and if the user credential cannot be verified, the connection is disapproved (step E2-3).

At step E3, upon the request from the approved user for modification to a property of the bit money, if the requested property of the bit money is in a normal state, the request is confirmed, and if anything unusual such as counterfeiting or falsification is found, an explanation thereof is requested and the modification request is not approved (step E3-11).

Step E4 verifies the approval institution for the bit money at the time of its generation, the type and amount of the bit money, and an encryption state for avoiding counterfeiting, falsification, duplication, etc. and approves the modification to the bit money if the transferee information of the bit money, the bit money properties, and the history details for the bit money information are normal (step E4-11).

For the external properties of the bit money, step E5 modifies properties such as transferee information and the encryption code to be used by a transferee.

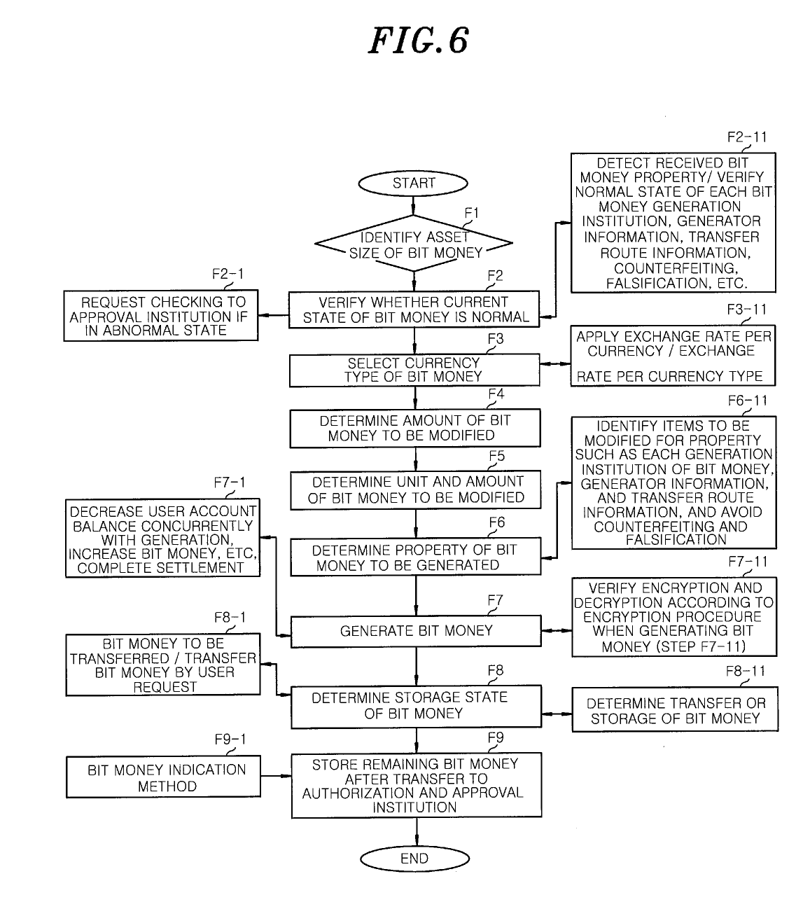

FIG. 6 is a flow chart for tasks performed when a user requests a modification to bit money to an approval institution.

Step F1 connects to the approval institution to check the asset size such as cash or bit money of the designated account possessed by the user.

Step F2 verifies each institution that generates bit money and is waiting at the approval institution, generator's information, and transfer route information on whether they are in a normal state or counterfeited, falsified, etc. (step F2-11). For bit money in an abnormal state, a fact-checking is requested to the approval institution.

Step F3 applies an exchange rate for each currency to each bit money (step F3-11) to select a type of currency after checking the limit for generation as bit money as calculated in the base currency. Step F4 checks and determines the amount of bit money to be modified according to the exchange rate of the exchange rate information system provided by the approval institution.

Step F5 determines the unit and amount of bit money to be modified.

Step F6 determines the generation institution for generating the bit money, information of the generator, and the transfer route, and identifies the items to be modified (step F6-11). When an error occurs, they are verified according to the error verification system of the approval institution.

Concurrently with the generation of bit money, step F7 identifies whether the balance of the user's account is decreased. When the balancing such as increase or decrease of bit money is completed (step F7-1), bit money is generated and its encryption and decryption are verified according to an encryption procedure during its generation (step F7-11).

Step F8 determines whether to transfer or store the modified and generated bit money (step F8-11). When transferring the bit money, the transfer is approved according to the user request (step F8-1).

Step F9 stores the remaining bit money after the transfer to the authorization and the approval institutions and indicates it in a file or image expression form to be visually identifiable (step F9-1).

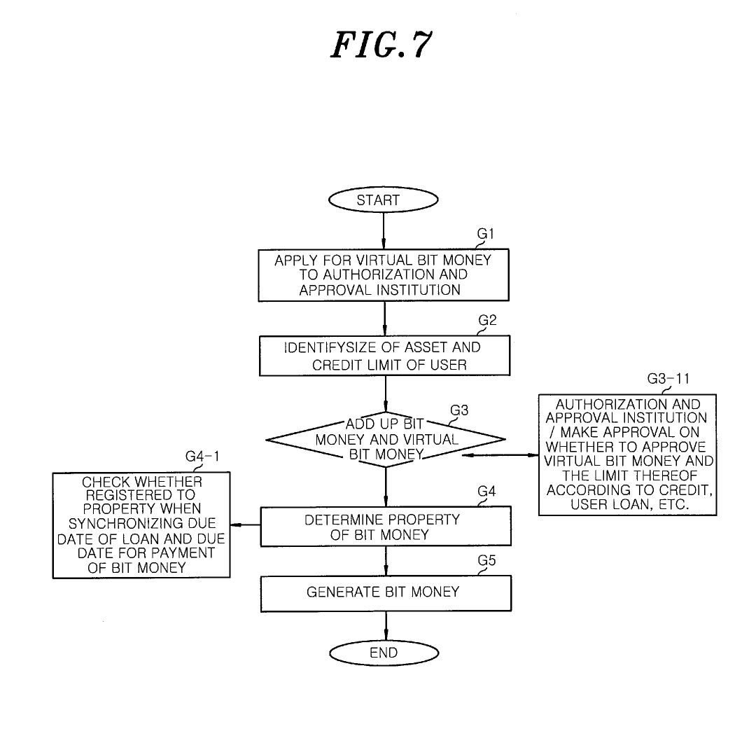

FIG. 7 is a flow chart for a user to apply for virtual bit money for taking out a loan from an approval institution and thereby generate real bit money.

At step G1, a user applies for virtual bit money to an authorization and approval institution on security of the user's tangible or intangible asset.

At step G2, the approval institution sets the size and credit limit of the virtual asset provided to the user.

At step G3, the approval institution makes approval according to criteria to the user on whether to approve virtual bit money and the limit thereof, and sums it up (step G3-11). In case of generating bit money with a given exchange period, it is synchronized with the due date for payment and applied to the property of the bit money.

At step G4, when the properties for each bit money to be generated are determined, the due date of loan and the due date for payment of bit money are synchronized and registered to the due date for payment of the properties (step G4-1). In other words, when the transfer date is included in the generating event message of the generator terminal, the transferee terminal cannot complete the transfer event message of the bit money until the transfer date.

Step G5 encrypts the bit money in the same manner as in its generation.

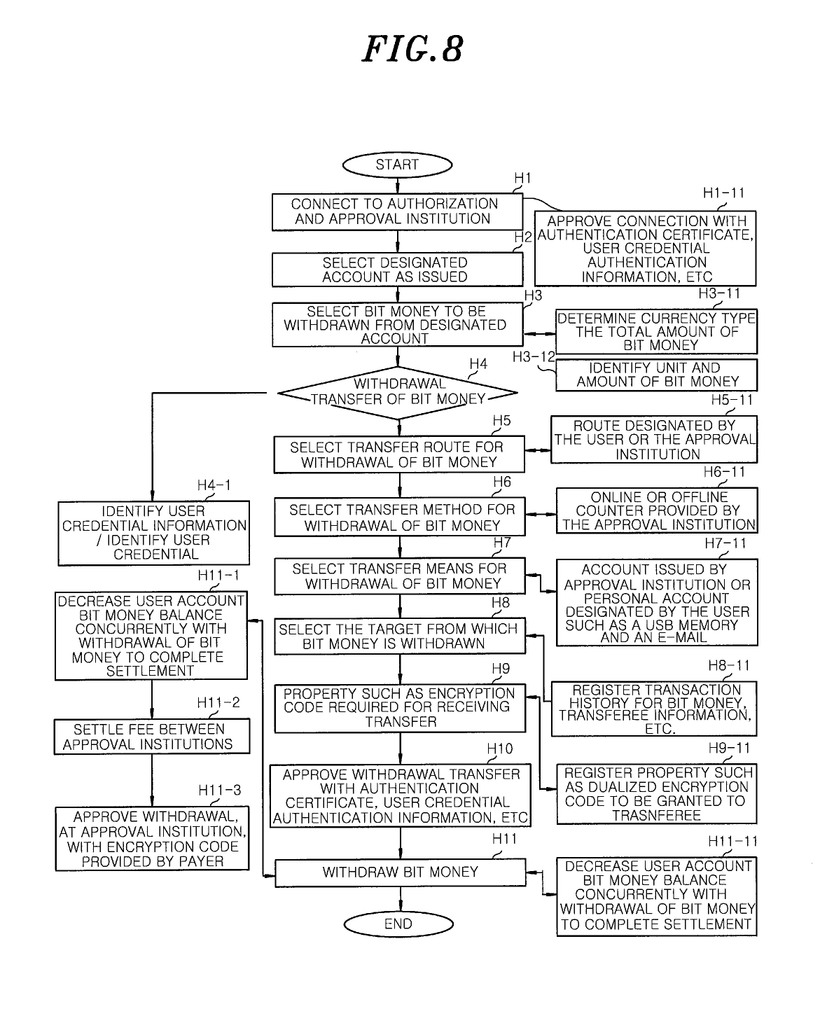

FIG. 8 illustrates a flow chart of withdrawal transfer of bit money.

Step H1 connects to an approval institution capable of handling financial transactions with an authentication certificate, user credential authentication information, etc. (step H1-11). In other words, the bit money distribution service providing server can receive the credential authentication information from the generator terminal and the transferee terminal via the approval institution and the authorizaion institution.

Step H2 selects the designated account granted from the approved institution. Step H3 determines the currency type and the total amount of the bit money to be transferred (step H3-11), identifies the unit and the amount (step H3-12), and then selects the bit money to be withdrawn from the designated account. Step H4 identifies the user credential at the approval institution to approve withdrawal of the bit money.

Step H5 selects the withdrawal route for the bit money through the route designated by the user or the approval institution to which the money is withdrawn and transferred (step H5-11).

Step H6 selects a transfer method for withdrawing bit money through visiting an offline counter of the approval institution (step H6-11) or through online methods such as internet banking and phone banking provided by the approval institution.

Step H7 selects transfer means required for withdrawal (receipt) of bit money through an account issued by the approval institution or a personal account designated by the user such as a mobile, a PC, a USB memory, a smart card, an e-mail, or a smart TV (step H7-11).

Step H8 registers the transaction history for the bit money to be paid or transferred by the user (step H8-11) and selects the target to be withdrawn.

Step H9 generates and forwards a dualized encryption code to be provided to the transferee (receiver) of the bit money (step H9-11).

Step H10 receives a transfer approval for withdrawal from the approval institution with an authentication certificate, user credential authentication information, etc.

Step H11 identifies the encryption code that the payer of the bit money forwarded to the person who receives the payment (the bit money transferee) and then makes approval thereon (step H11-11). The settlement is completed by decreasing the bit money balance of the user account concurrently with the withdrawal of the bit money (step H11-1). In this process, the fees incurred from the approval institution or between the approval institutions are settled as well (step H11-2).

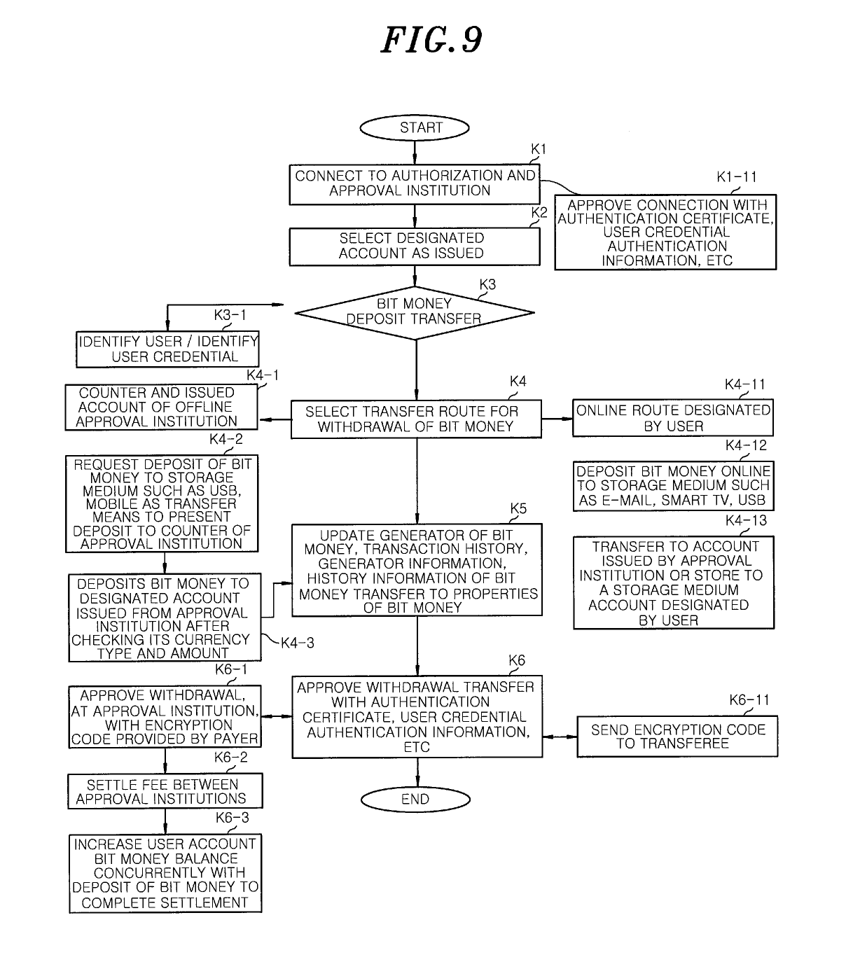

FIG. 9 illustrates a flow chart of deposit transfer of bit money.

Step K1 connects to an approval institution capable of handling financial transactions with an authentication certificate and a user credential authentication information (step K1-11).

Step K2 identifies and selects a designated account granted from an approved institution. Step K3 identifies, at the approval institution, the user credential to authorize a transfer for deposit of bit money.

At step K4, a user who received a payment selects a designated account of the approval institution or a storage medium for depositing the bit money.

When step K4-1 requests, at an offline counter of the approval institution, deposit of bit money to a storage medium, as a bit money transfer means, such as a USB memory, mobile, smart TV, game console with communication capability, etc. (step K4-2), the approval institution deposits it or stores it as bit money to the designated account issued to the user after checking its currency type and amount (step K4-3). The bit money deposited online through a storage medium such as an e-mail, a smart TV, a USB memory, a mobile, or a game console with communication capability (step K4-12) is transferred to the user account issued by the approval institution or transferred and stored to a storage medium designated by the user (step K4-13).

Step K5 updates the generator, transaction history, transferee, history information of bit money transfer, etc. to the properties with respect to the deposited bit money.

At step K6, a user who receives the payment with the bit money is approved with the encryption code for the transferee (step K6-1). The bit money is exchanged with cash with an authentication certificate, user credential authentication information, etc. The bit money balance of the user designating account is increased concurrently with the deposit of the money, and the transaction is completed (step K6-3). After the transaction, the fee for the approval institution is settled (step K6-2), and the settlement between approval institutions that generated bit money is also processed together (step K6-11).

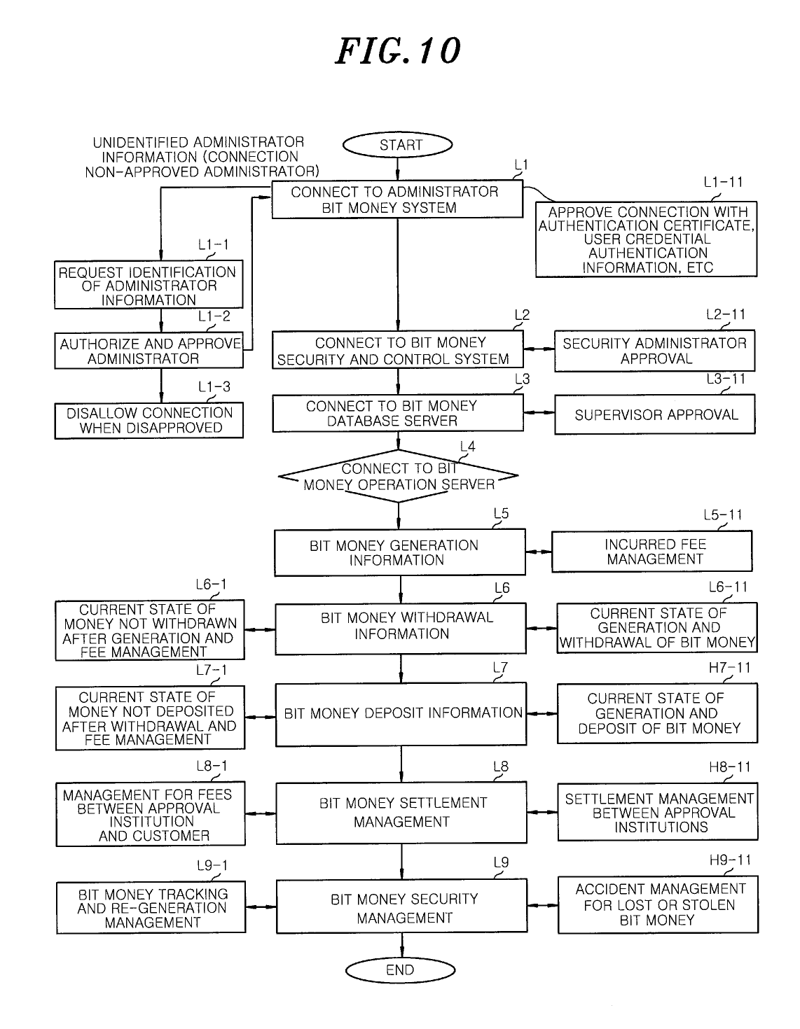

FIG. 10 is a diagram illustrating task operations for a bit money administrator in an authorization institution to improve work efficiency in accordance with the characteristics of bit money.

Step L1 connects with an authentication certificate and administrator credential authentication information (step L-11). An unidentified administrator is approved by identifying his/her credential authentication according to an administrator identification procedure (step L1-1), and an administrator not identified to have credential requests a credential authentication to be approved (step L1-2). Further, an administrator whose credential authentication is not authorized is disapproved for connecting to a bit money operation server (step L1-3) so that only an administrator who has been through the credential authentication may connect to the bit money system.

Step L2 allows, among the approved administrators, only an administrator who received a security approval from a security administrator (step L2-11) to access a security and system for the bit money. Step L3 configures a tri-level administrator security system such that a security supervisor authorizes an administrator who received a security approval (step L3-11) to access a bit money database server. Step L4 grants the administrator who has been through the security approval an authorization to access the bit money operation server and tasks.

Step L5 manages fees according to generation of bit money (step L5-11) and manages customer bit money generation information.

Step L6 manages the current state of generation and withdrawal of the bit money by a customer (step L6-11), the current state of the bit money not withdrawn after its generation, the settlement of a loan management fee for cash in storage after generation of the bit money (step L6-1), and withdrawal information of the bit money.

Step L7 manages the current state of withdrawal and deposit of the bit money (step L7-11), fees while the bit money is not deposited after withdrawal (step L7-1), and the bit money deposit information.

Step L8 performs bit money settlement management such as settlement management between approval institutions (step L8-11) and management for fees with customers (step L8-1).

Step L9 performs management for bit money generation and the follow-up management such as accident management for lost or stolen bit money of a customer (step L9-11) and bit money tracking and re-generation management against an unconscionable transaction or an illegal transaction (step L9-1).

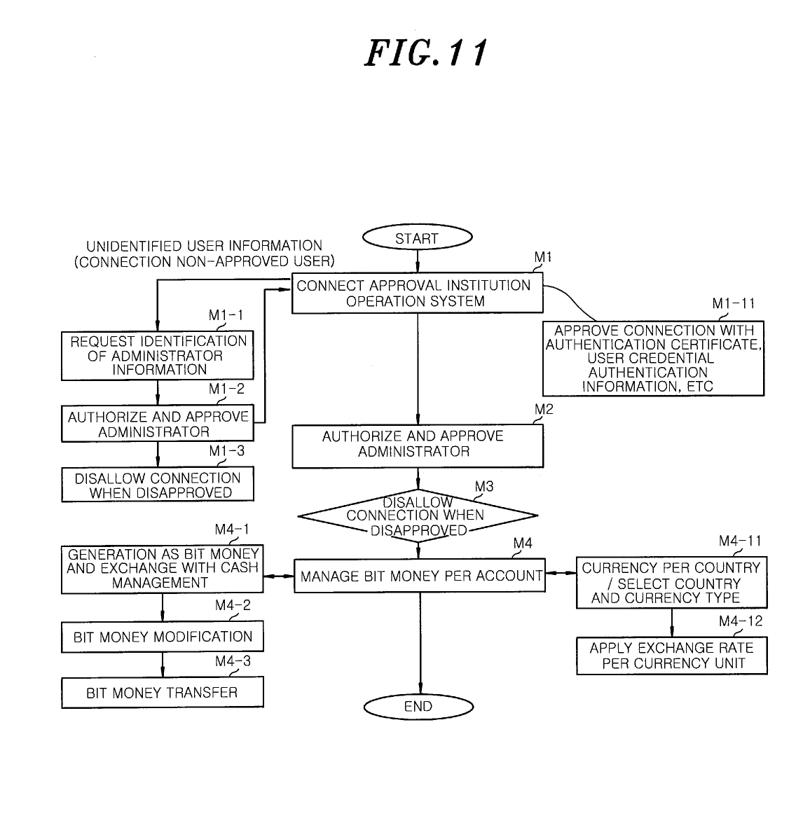

FIG. 11 is a diagram illustrating operations of bit money by a user in an approval institution.

Step M1 connects to the bit money system with an authentication certificate, user credential authentication information, etc. (step M1-11). An unidentified user requests a user information to an administrator to receive an identification therefrom, and connects to the system (step M1-1). An unidentified user requests approval for connection (step M1-2) and connects to the system after the approval. A disapproved user is disallowed to connect to the system for the security management (step M1-3). Only qualified users are allowed to connect to the bit money user operation server.

At step M2, a user who received approval for connection connects to a user account issued from the approval institution. Step M3 connects to the user account in the approval institution and accesses bit money information such as an account balance. Step M4 manages cash possessed by the user and bit money per currency type to which the exchange rate information system provided by the approval institution is applied (step M4-11). Further, withdrawal and bit money and cash in storage are managed (step M4-1), while performing asset management by managing interest fees incurred from the loan, interest fees resulting from receipt from another approval institution, and the like. Further, bit money can be changed to cash and cash can be changed to bit money (step M4-2), and it is managed after transfer for withdrawal through other storage medium.

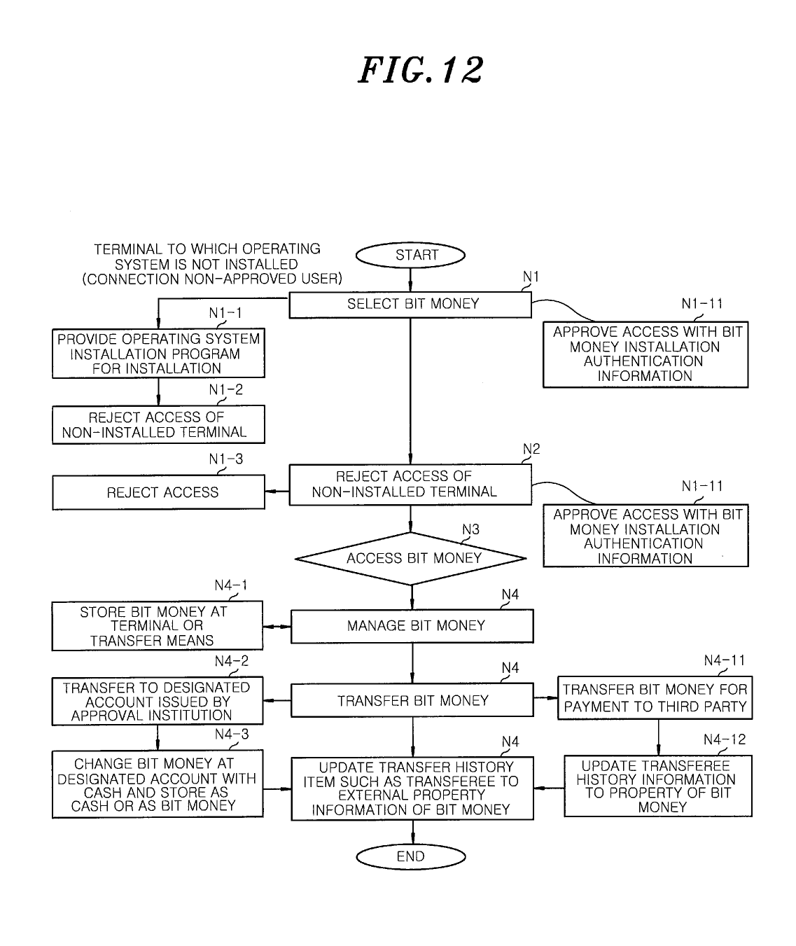

FIG. 12 is a diagram illustrating operations of bit money between users outside an approval institution.

Step N1 connects to a bit money operation system provided by the approval institution (step N1-11). A program is provided so that a dedicated system is installed to a terminal to which an operating system is not installed (step N1-1) to allow connection to the bit money system after installation, where a user who has not installed it is not allowed for connection (step N1-2).

Step N2 approves access if a credential authenticated by the approval institution is identified (step N2-11), and, if a credential is not identified, approves access after being requested and identifying a credential, and rejects access of a user without a credential (step N2-2).

Step N3 allows a user who has an installed dedicated system for bit money and whose access credential is identified to access bit money. Herein, a transferee of bit money can access the bit money after installation of the dedicated system for bit money. Step N4 stores bit money in online/offline transfer means for bit money such as a mobile, a PC, a USB memory, a smart card, an e-mail, a smart TV, a game console with communication capability, other storage medium, etc. (step N4-1).

At step N5, a user may transfer (deposit) the bit money in possession to an account designated by the user and issued by the approval institution, when transferring it for the settlement or storage thereof (step N5-1). It is stored as bit money at the designated account issued by the approval institution or stored as cash after being exchanged with cash (step N5-2). Step 5-11 makes a payment using transfer means such as a mobile, a PC, a USB memory, a smart card, an e-mail, a smart TV, a game console with communication capability, or other storage medium, when transferring bit money for payment to a third party (step N5-12).

Step N6 checks and updates history items such as the transferee, transaction information to the external property information of the property (step N6).

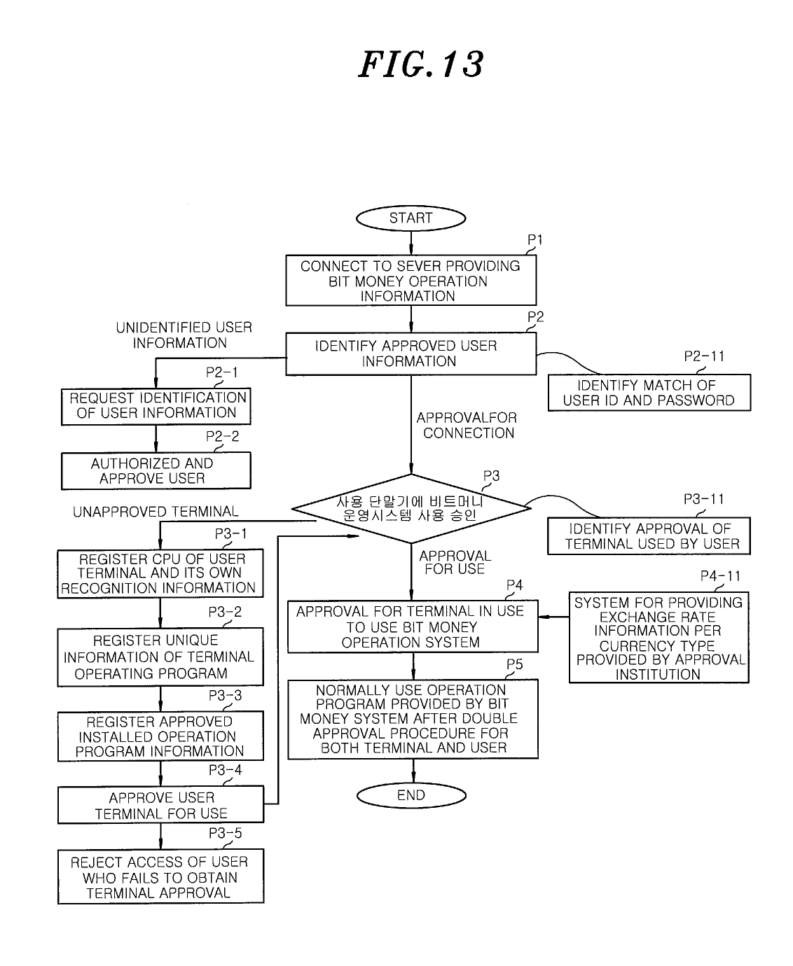

FIG. 13 is an operation diagram of a dedicated system for bit money.

Step P1 connect, at a user terminal, to a dedicated system for bit money. If a dedicated system is not installed, an installation program is provided for installing the dedicated system.

Step P2 inputs user's credential authentication information or private information such as ID and password to enable a user to access the dedicated system for the bit money (step P2-11). If the user is unidentified, identification thereon is requested with the user information (step P2-1) and approval is received after the identification (step P2-2).

Step P3 permits the user's access, if the terminal to be used by the user connects to the dedicated system for bit money is approved by a bit money operation server (step P3-11). If the terminal is unidentified, approval is requested to the bit money operation server with the CPU of the user terminal and its own hardware recognition information to receive approval for the terminal to be used (step P3-1) and receive approval with a unique information of the operating system of the terminal (step P3-2). Approval for the installed system dedicated for bit money is requested to the bit money operation server at the terminal whose hardware and software are approved (step P3-3) to receive approval for use, which constitutes a double approval (step P3-4). A user who has been through the double approval procedure and the user's terminal are approved for access to the dedicate system for bit money and a user who fails to be approved is disapproved for access (step P3-5). At step P4, a user connects to the bit money operation server with the approved terminal and uses the dedicated system for bit money and the exchange rate information provider system provided by the approval institution (step P4-11).

At step P5, a user with the double approval normally uses the bit money operation program provided by the approval institution at the approved terminal(step P5).

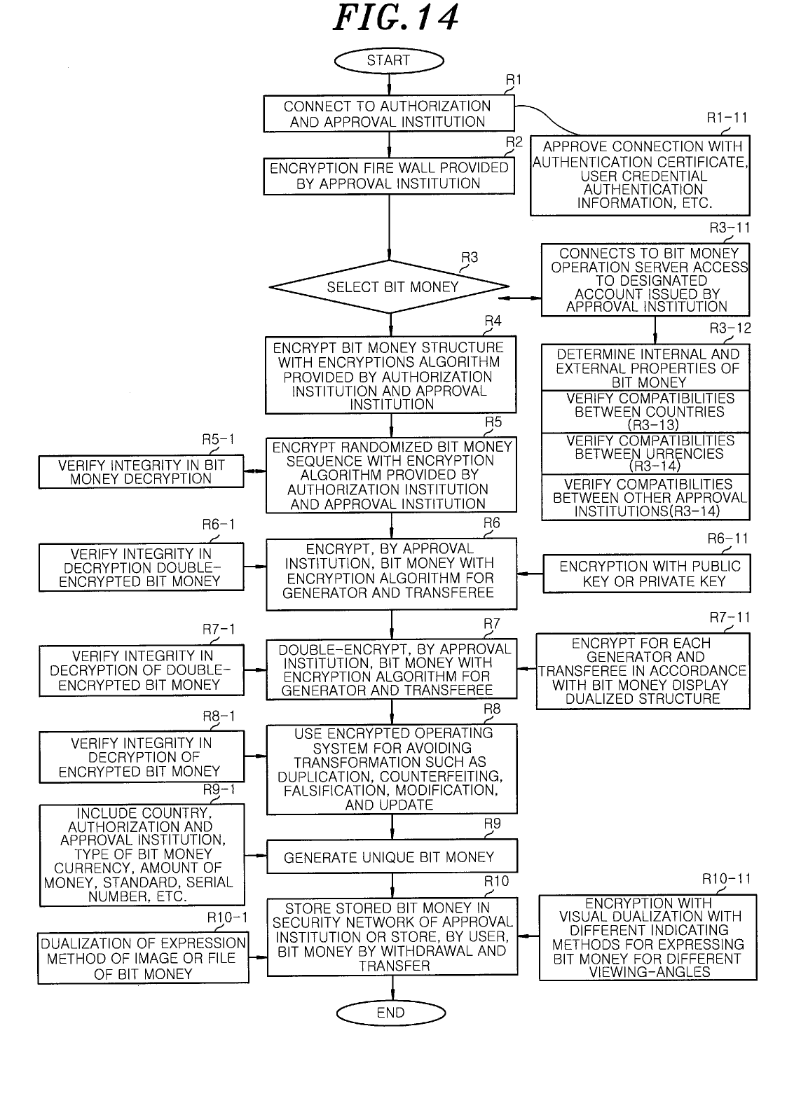

FIG. 14 is a basic diagram illustrating double encryption and encryption display dualization of an online bit money system.

Step R1 connects to a bit money system provided by an approval institution with an authentication certificate, a user credential authentication information, etc. (step R1-11).

Step R2 receives approval for use by a user at an encryption firewall provided by the approval institution.

Step R3 connects to a bit money operation system to access to information of a designated account issued by the approval institution (step R3-11). Bit money is selected to determine its internal and external property histories (step R3-12), compatibilities between countries are verified (step R3-13), compatibilities between currencies are verified, bit money compatibilities between other approval institutions are verified (step R3-15), and it is synchronized with the exchange rate information system provided by the approval institution (step R3-14).

Step R4 encrypts a bit money hierarchy with a public and a private key encryptions algorithm provided by an authorization institution and the approval institution.

Step R5 encrypts the randomized bit money sequence with the encryption algorithms provided by the authorization institution and the approval institution for the double encryption. In this process, integrity in bit money decryption is verified to reduce errors in using the bit money (step R5-1). In other words, the bit money distribution service providing server can verifies the integrity during the encryption and the decryption of at least one information included in the bit money.

At step R6, the approval institution encrypts the bit money with a public or private encryption algorithm for the approval institution and the user who generates the bit money (step R6-11). In this process, integrity in decryption of the double-encrypted bit money is verified (step R6-1). The generator encryption code and the transferee encryption code can be encrypted with a private key and a public key.

At step R7, the approval institution encrypts the properties with the dualized hierarchy to be used in each terminal display for enabling the generator of bit money and the user to whom it is transferred to safely and conveniently use the bit money system (step R7-11). For the bit money properties, integrity in decryption of the dualized encryption is verified. In this process, a pair of encryption codes to be used by the payer and the transferee are dualized and dimensionalized with the encryption browser to be used by each user so that they are activated only on the terminal browser for which the user receives approval (step R7-1).

Step R8 encrypts the bit money in the encrypted operating system environments of the approval institution to avoid transformation such as duplication, counterfeiting, falsification, modification, and update of the bit money, while verifying integrity in decryption of the encrypted bit money (step R8-1).

At step R9, the double-encrypted and dualized properties of the bit money includes the country, authorization and approval institution, type of bit money currency, amount of money, standard, serial number, etc. (step R9-1).

Step R10 employs different indicating methods for expressing the bit money image or file for different viewing-angles (step R10-1), provides the bit money as being dimensionalized and encrypted for avoiding duplication, counterfeiting, and falsification, while it is visually identifiable (step R10-1). The stored bit money is stored in the security network of the approval institution or is stored by the user as the user withdraws it.

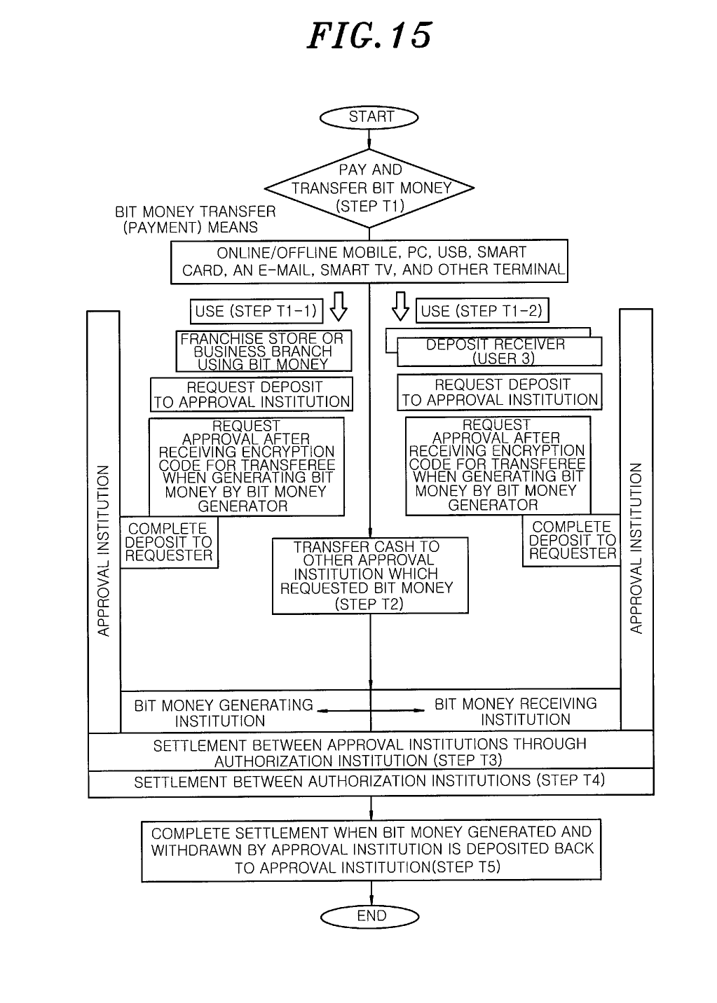

FIG. 15 is a basic diagram illustrating a settlement between bit money approval institutions.

Step T1 transfers bit money for payment, modification of storing location, etc. using online/offline bit money transfer means for payment such as a mobile, a PC, a USB memory, a smart card, an e-mail, a smart TV, a game console with communication capability, and other storage medium. Here, the generator terminal can transfer the bit money to the transferee terminal through any one of an e-mail of the transferee terminal, a smart terminal, a PC, a smart card, a USB memory and a smart TV.

Step T1-1 pays a franchise store or a business branch in using the bit money. The franchise store or the business branch which receives payment with bit money requests deposit of the received bit money to the approval institution to deposit it to a designated account and exchange it with cash or store it as bit money. The transferee (person who receives the payment) receives the encryption code required for requesting approval from the person who generated the bit money during the payment to request the approval, and then the deposit from the approval institution is completed.

At step T1-2, in case of using bit money for payment, the person who receives deposit (payment) may request deposit to the approval institution or pay another user again. In this step, approval is requested after receiving the encryption code from the person who generated bit money, and the approval institution deposits he bit money to the account designated by the transferee. Herein, the received bit money is exchanged with cash or stored as a state of bit money.

At step T2, the approval institution that received a deposit as bit money requests the approval institution that generated the bit money to exchange the bit money with cash to make settlement.

Step T3 settles fees between the institution that received the bit money and the institution that generated the bit money through an authorization institution.

At step T4, the approval institution settles taxes and procedures designated by each authorization institution for deposit of the bit money in case where the country in which bit money is used and the country in which the bit money is generated are different.

Step T5 settles fees incurred from generation to transfer and exchange of bit money when the bit money was withdrawn from the approval institution which generated the bit money and then is deposited back.

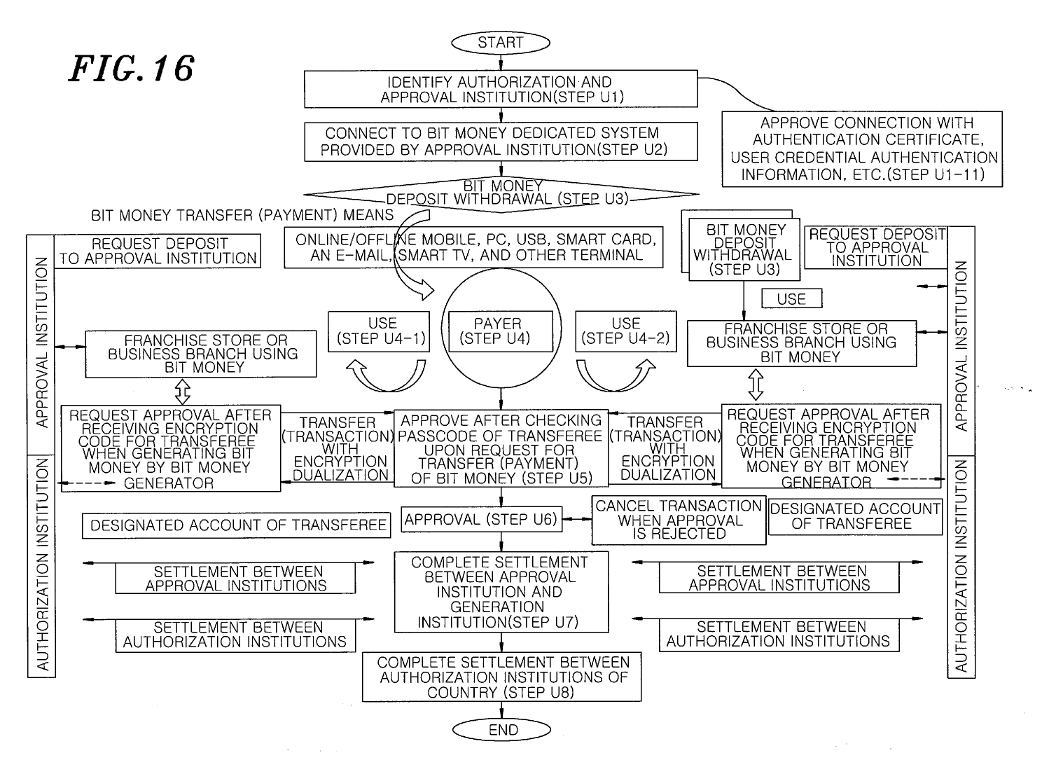

FIG. 16 is a block diagram of an encryption code display dualization for bit money operation.

Step U1 approves connection to a bit money server of an authorization and approval institution with an authentication certificate, a user credential authentication information, etc. (step U1-11).

Step U2 connects to an encrypted bit money dedicated system provided by the approval institution.

Step U3 transfers bit money for deposit and withdrawal using an online/offline mobile, a PC, a USB memory, a smart card, an e-mail, a smart TV, a game console with communication capability, or other storage medium.

At step U4, when the person who pays a franchise store and business branch at which bit money can be used (the generator of bit money, the transferor) uses bit money (step U4-1), the franchise store and business branch request the approval institution to deposit the received bit money. When receiving payment, the transferee (a person who receives the payment) receives an encryption code from the generator of the bit money. Approval is requested and received on the bit money system after having the encryption code required for identification of deposit verified from the approval institution through acquisition means.

At step U4-2, in case of paying with bit money, the person who receives deposit (payment) receives payment with bit money and may request deposit to the approval institution on the bit money system or pay another user again. Further the user who received payment with bit money may use the bit money at a franchise store and business branch accepting bit money.

If the user who received payment with bit money requests approval on the bit money system after receiving the encryption code for the transferee, the deposit from the approval institution to the account at the approval institution designated by the transferee is completed. At step U5, when the transferee who received payment with bit money requests approval to the generator (payer), the generator (payer) checks the authenticity of the passcode granted to the transferee and makes approval at the encryption dualization system. Herein, the approval institution transfers the bit money to the account designated by the bit money transferee. The transferred bit money is exchanged with cash or stored in a state of bit money.

At step U6, if the transferee who received payment after a transaction requests approval to the payer, the payer makes approval. If the payer rejects approval, the transaction is canceled.

Step U7 makes settlement between the approval institution which generates the bit money and the approval institution which receives and deposits the bit money.

Step U8 makes settlement between the approval institution and the authorization institution such as items to be reported according to work procedures and taxes imposed thereon, in case where the country in which the bit money is used and the country in which the bit money is generated are different.

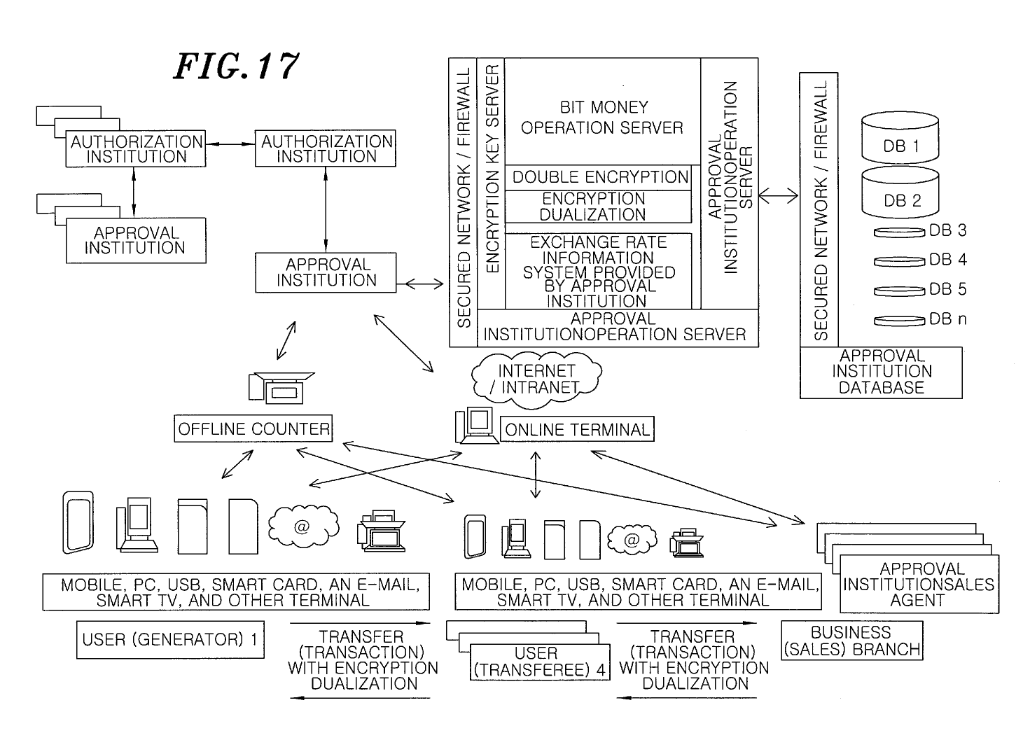

FIG. 17 is a block diagram of a system for providing a bit money service.

Each authorization institution refers to a national institution and an approval institution is a financial institution which the authorization institution approves to handle financial transactions. The approval institution has a secured network and a firewall to protect an operation server, where an encryption key server and a bit money operation server with double encryption and encryption dualization are installed to the operation server. The bit money operation server is synchronized with the exchange rate information system provided by the approval institution so that the exchange rate is applied to generation of the bit money. The dualized secured network and the firewall are installed to database servers provided to various operation servers. For an offline transaction of bit money, a user visits the approval institution to receive or deposit bit money through bit money transfer means such as a mobile, a PC, a USB memory, a smart card, an e-mail, a smart TV, a game console with communication capability, or other storage medium. A store and a sales agent designated by the approval institution make settlement with bit money as payment means for sales activities. For an online transaction served by the approval institution, bit money is transferred or paid through bit money transfer medium such as a mobile as transfer medium through internet banking, phone banking, etc., a PC, a USB memory, a smart card, an e-mail, a smart TV, a game console with communication capability, or other storage medium. The parties concerned with a use of the bit money comprise a first user who generated (issued) bit money and a number of users, i.e., a second to Nth users, who receive payment from the generator or to whom the bit money is transferred. In addition, they further comprise a sales agent for whom the approval institution approves bit money as payment means.

The bit money transfer between the parties above comprises deposit and withdrawal of bit money for storage and payment, and the transaction is settled such that the transferee who received payment requests approval and the payer makes approval at a bit money dedicated system with double encryption.

### SEQUENCE LIST FREE TEXT

### Descriptions for Principal Part of Drawings

Bit Money: title of intangible currency managed as data

Bit Money Property: items regarding hierarchy of bit money, classified into an internal property and an external property.

Authorization Institution: national institution in charge of financial policy

Approval Institution: financial institution to which an authorization delegates financial transactions

Generation: exchanging cash possessed by an approval institution with bit money

Decryption: process or processing method of restoring encrypted or encoded information back before the encryption

Integrity: maintaining and guaranteeing accuracy and consistency of bit money such that the hash values of two different data are identical

Bit Money Indication: a form in which a file or image generated as bit money is expressed

Double Encryption: method of encrypting the internal property of bit money and encrypt again the encrypted bit money for its external property.

Encryption Dualization: method for encryption of allowing bit money items to be seen only when the generator of bit money and the transferee input encryption codes respectively granted to the generator and the transferee at the respective browsers.

Supervisor: chief security administrator of an approval institution approving and managing database accesses and administrators.

Incurred Fee: management fee incurred when an approval institution generates (issues) or receives and deposits bit money

Capsule Security: two-way security structure linking both authentication and encryption

Visual Dualization: dimensionalized expression form of showing different shapes for different viewing angles

1-17. (canceled)

18. A method for providing bit money distribution service provided at a server for providing intangible bit money distribution service comprising:
receiving creation event message that bit money has been created by a creator terminal, via an authorization institution server, the creation event message including creator information, amount information, distribution history information, and creator encryption code information;
storing the creator information, the amount information, the distribution history information, and the creator encryption code information;
transmitting the creator information, the amount information, the distribution history information, and the creator encryption code information to a transferee terminal to which the creator terminal transfers bit money;
via the authorization institution server and an approval institution server, receiving from the transferee terminal a transfer event message that the bit money has been transferred to the transferee terminal;
when a payment event message is received by the transferee terminal, transmitting approval confirmation on the transmission of the creator encryption code information to the creator terminal; and
when receiving approval confirmation data from the creator terminal, transmitting the payment event message received from the transferee terminal to a store terminal installed in a store via the authorization institution server and the approval institution server,
wherein the server for providing bit money distribution service, in response to the creation event message, dualizes the creator encryption code of the creator terminal and a transferee encryption code of the transferee terminal as a pair of encryption codes such that they are activated only at the creator terminal and the transferee terminal,
when the transfer event message is received by the transferee terminal, updating history information from the creator terminal to the transferee terminal to the distribution history information, and
when confirmation data on the payment event message is received from the store terminal, updating history information from the transferee to the store to the distribution history information.

19. The method for providing intangible bit money distribution service of claim 18, further comprising before transferring the bit money from the creator terminal to the transferee terminal is completed, receiving a creator encryption code input of the creator terminal and a transferee encryption code input of the transferee terminal, and comparing the creator encryption code and the transferee encryption code with pre-stored encryption code data.

20. The method for providing intangible bit money distribution service of claim 18, wherein at least one information for the bit money is encrypted with a private key and a public key, and then re-encrypted with the creator encryption code and the transferee encryption code.

21. The method for providing intangible bit money distribution service of claim 18, wherein if the creation event message includes a transfer due date, the bit money is not transferred to the transferee terminal until the transfer due date.

22. The method for providing intangible bit money distribution service of claim 18, further comprising:
receiving credential authentication information from the creator terminal and the transferee terminal via the authorization institution server and the approval institution server.

23. The method for providing intangible bit money distribution service of claim 18, wherein the creation event message further includes bio metric information and an identification number and the server receives bio metric information and identification number of a user of the transferee terminal from the transferee terminal after the bit money is transferred to the transferee.

24. The method for providing intangible bit money distribution service of claim 18, wherein the bit money is displayed with a barcode or an image code.

25. The method for providing intangible bit money distribution service of claim 18, wherein
when the creation of the bit money from the creator terminal is completed, the server decreases a first amount of money from possessed money of the creator terminal and increases concurrently a second amount of the bit money based on the first amount using an equality function algorithm.

26. The method for providing intangible bit money distribution service of claim 18, wherein integrity is checked upon the encryption or decryption of at least one information for the bit money.

27. The method for providing intangible bit money distribution service of claim 18, wherein the creator encryption code and the transferee encryption code are encrypted with a private key and a public key.

28. The method for providing intangible bit money distribution service of claim 18, wherein the creator terminal transmits the bit money to the transferee terminal through one of an e-mail of the transferee terminal, a smart terminal, a desktop computer, a smart card, a USB memory, or a smart TV.

29. The method for providing intangible bit money distribution service of claim 18, wherein the bit money includes a unit corresponding to at least one type of currency.

30. The method for providing intangible bit money distribution service of claim 18, wherein the information included in the creation event message for the bit money, the history information from the creator to the transferee, the history information from the transferee to the store, and the transferee encryption code are stored as binary bit data or bit data.
